(19) United States
(12) Patent Application Publication
(10) Pub. No.: US 2024/0269660 A1
(43) Pub. Date: Aug. 15, 2024

(54) OXIDATIVE AND ADSORPTIVE CATALYTIC MEDIA

(71) Applicants: Alden Bruce Badger, North Chesterfield, VA (US); Everett Earl Carpenter, Mechanicsville, VA (US); Bruce R. Kitchen, Richmond, VA (US)

(72) Inventors: Alden Bruce Badger, North Chesterfield, VA (US); Everett Earl Carpenter, Mechanicsville, VA (US); Bruce R. Kitchen, Richmond, VA (US)

(21) Appl. No.: 18/439,130

(22) Filed: Feb. 12, 2024

Related U.S. Application Data
(60) Provisional application No. 63/484,347, filed on Feb. 10, 2023.

(51) Int. Cl. B01J 35/00; B01J 21/04; B01J 35/32; B01J 35/40; B01J 35/53; B01J 35/61; C02F 1/72; C02F 101/10; C02F 101/20; C02F 101/36

(52) U.S. Cl. CPC B01J 35/19; B01J 21/04; B01J 35/32; B01J 35/40; B01J 35/53; B01J 35/615; C02F 1/725; C02F 2101/101; C02F 2101/103; C02F 2101/203; C02F 2101/36; C02F 2305/023

(57) ABSTRACT

A supported metal oxide nanocatalyst media includes periodate moieties chemisorbed to activated alumina. The supported mixed metal oxide nanocatalyst media can be porous granular particles or powder in mesh sizes ranging from about 30 microns to about 2,500 microns. The media acts as both an oxidant and an adsorbent and can remove organic and inorganic contaminants simultaneously.

### CROSS REFERENCE TO RELATED APPLICATIONS

This application claims the benefit of U.S. Provisional Pat. App. No. 63/484,347, filed Feb. 10, 2023, which is incorporated by reference herein in its entirety for all purposes.

### FIELD

The present invention relates to catalytic contaminant removal. More particularly, it relates to oxidative and adsorptive catalytic media to remove fluid-borne contaminants.

### BACKGROUND

Water purification is the process of removing undesirable chemicals, biological contaminants, suspended solids, and gases from contaminated water. In countries that lack access to clean water, water purification and removing water borne contaminants is a serious concern. Organic contaminants can include but are not limited to color, due to tannins, for example, an undesirable odor; total organic carbon (TOC); volatile organic compounds (VOC), such as thiols; bacteria; and an undesirable taste. Inorganic contaminants may include metals, metalloids, and nonmetals, such as iron, arsenic, radium, uranium, phosphate, selenium, and hydrogen sulfide (H2S). Many municipalities have experienced difficulties producing odor-free, taste-free, and clear drinking water from a contaminated water source.

Another category of organic contaminants includes but is not limited to perfluorooctanesulfonic acid (“PFOS”), perfluorooctanoic acid (“PFOA”), and per- and polyfluoroalkyl substance (“PFAS”). PFOS, PFOA, and PFAS, e.g., from process-water, and waste-water streams, are known to persist in the environment, including in drinking water sources, and are commonly described as persistent organic pollutants and are referred to as “forever chemicals.”

Ion exchange resins are solid matrices which carry exchangeable ions and are used to remove undesirable ionic contaminants from water. Ion-exchange media adsorb contaminants but do not oxidize them, which can limit their effectiveness. Moreover, ion-exchange resins typically become ineffective when coated with a biofilm.

Chemical oxidation may be used to remove color, odor, organic compounds, and inorganic compounds from water, using oxidants such as chlorine, ozone, oxygen, peroxide, and permanganate. The addition of chlorine to water containing TOC creates carcinogenic disinfection byproducts. In addition, chlorine can cause water to have or “take on” an undesirable odor and/or taste, rendering such water unfit for addition to, e.g., products prepared or produced by food and/or beverage industries.

It is known to use an antimicrobial polymeric oxidizing adsorbent medium or an iron oxide on metaperiodate-treated alumina sorbent to remove arsenic from water. See U.S. Pat. No. 7,300,587B2 to Smith et al., the disclosure of which is incorporated in its entirety.

As can be seen there is a need for water treatment technology that both adsorbs and oxidizes contaminants, is not subject to “bio-fouling”, does not produce carcinogenic byproducts, and is effective to reduce or eliminate a wide variety of contaminants in a single step or stage.

### SUMMARY

The present subject matter is directed to a supported mixed metal oxide nanocatalyst media which includes a periodate moiety bonded to a substrate. The supported mixed metal oxide nanocatalyst media simultaneously oxidizes and adsorbs water-borne contaminants such as heavy metals, volatile organic compounds, persistent fluorocarbons, and biological organisms. In operation, the periodate moiety provides an electron sink for generating preselected metal oxide ionization potential states or values, i.e., it helps regenerate the metal oxidation state. The media provides an extended adsorption capacity as compared to prior art ion exchange resins.

While the catalytic media disclosed herein may be used to remove contaminants from fluids like water, it is not limited to those fluids. Other fluids such as fruit and vegetable juices, solvents, natural gas condensate and other petroleum fluids can be treated. The catalytic media is effective in removing contaminants including undesirable odor, taste, and color, from water. The subject matter media also reduces Total Organic Carbon without creating disinfection byproducts.

Surprisingly, it has been found that the supported mixed metal oxide nanocatalyst media of the present subject matter, when contained in a vessel adapted and configured for fluid to pass through it, removes a wider range of contaminants at higher throughput rates than currently available ion-exchange media, and is thus more efficient. The catalytic media provides sufficient oxygenation to simultaneously remove both organic and inorganic contaminants chemisorbed to the substrate. In particular, it has the ability to both adsorb and oxidize organics and inorganics simultaneously. This unique ability eliminates the need to add an oxidant to the treatment stream to achieve effective contaminant adsorption. Moreover, the nanocatalyst media doesn't add de-toxification materials or chemicals to the effluent and does not produce vinyl chloride during removal of VOCs, a byproduct that results from some existing water treatment processes.

The ability to remove radium and uranium simultaneously was unexpected. The same is true of color and odor removal.

According to an embodiment of the present invention, the periodate moieties are chemisorbed to the activated alumina. The chemically bound periodate moiety does not release iodine into the effluent stream.

According to an embodiment of the present invention, the mixed metal oxide nanocatalyst media supported on an alumina substrate is in the form of porous granular particles, spheres or powder in mesh sizes ranging from about 30 microns to about 2,500 microns.

According to an embodiment of the present invention, the supported mixed metal oxide nanocatalyst media may have a surface area of about 200 to about 380 square meters per gram.

According to an embodiment of the present invention, a bulk density of the nanocatalyst media may range from about 25 pounds/cubic foot to about 75 pounds/cubic foot.

According to an embodiment of the present invention, periodate moieties are bonded to the activated alumina to produce an oxidant. The activated alumina provides a large surface area, adsorption capacity, and structure for the supported mixed metal oxide nanocatalyst media to form with the plurality of chemisorbed periodate moieties.

According to an embodiment of the present invention, the oxidant may have a surface thickness ranging from about 0.1 microns to about 10 microns.

A periodate is an anion composed of iodine and oxygen with iodine existing in oxidation state +7 that exists in a metaperiodate (IO₄⁻) or orthoperiodate (IO₆⁵⁻) form. It can combine with counter ions to form salts of periodic acid. In water, the dominant form of periodate is orthoperiodate, which behaves as a polyprotic acid.

According to an embodiment of the present invention, the nanocatalyst media exhibits one or more of the following advantages: a) better quality of treated water (i.e. low levels of ionic impurities) as compared to water treated with conventional strong acid cation resins under identical operating conditions; b) higher efficiencies than those for conventional resins; and c) lower water requirement (water saving or less effluent) as compared to prior art ion exchange resins.

According to an embodiment of the present invention, the nanocatalyst media exhibits core shell morphology.

According to an embodiment of the present invention, the nanocatalyst media does not exhibit core shell morphology.

According to an embodiment of the present invention, the nanocatalyst media exhibits advantages in one or more applications such as water treatment, preparation of ultrapure water, condensate polishing, catalysis, and sugar processing, etc.

### BRIEF DESCRIPTION OF THE DRAWINGS

The accompanying drawings illustrate various embodiments of systems, methods, and embodiments of various other aspects of the disclosure. A person with ordinary skill in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a photograph of nanocatalyst media according to an embodiment of the present invention;

FIG. 2 is a photomicrograph thereof;

FIG. 3A is an x-ray photoelectron spectra of a surface thereof;

FIG. 3B is a detail view thereof, illustrating region binding energies of 612-634 eV;

FIG. 4 is a flowchart of a process for the preparation of the nanocatalyst media of FIG. 1;

FIG. 5 is a schematic view of a particle of the nanocatalyst media of FIG. 1; and

FIG. 6 is a schematic view of a method of water treatment using the nanocatalyst media of FIG. 1.

### DETAILED DESCRIPTION

The present subject matter is directed to supported mixed metal oxide nanocatalyst media comprising periodate moieties chemisorbed to activated alumina. Alumina has been demonstrated as a nanocatalyst to improve the performance characteristics of combustion engines as well as a catalyst support for many organic reactions. See, for example, Hosseini, S. H., et al., (2017), “Effect of added alumina as nano-catalyst to diesel-biodiesel blends on performance and emission characteristics of CI engine”, Energy, 124, 543-552; Poreddy, R., et al., (2014), “Silver nanoparticles supported on alumina—a highly efficient and selective nanocatalyst for imine reduction”, Dalton Transactions, 43(11), 4255-4259; and Nikoofar, K., et al., (2019), “Nano alumina catalytic applications in organic transformations”, Mini-Reviews in Organic Chemistry, 16(2), 102-110. Alumina mixed metal oxide catalysts such as alumina/ferric oxide have been used in wastewater treatment. See, for example, Nguyen, T. T., et al., (2021), “Synthesis of natural flowerlike iron-alum oxide with special interaction of Fe—Si—Al oxides as an effective catalyst for heterogeneous Fenton process”, Journal of Environmental Chemical Engineering, 9(4), 105732. Iodine has been added to a Pd/Alumina catalyst to boost the stability of metal ions on the surface of the alumina. See Zeng, Y. Y., et al., (2023), “Dispersed Pd/alumina catalyst with finite iodine entry for boosted CO purification and dimethyl carbonate synthesis”, Chemical Engineering Journal, 466, 143348. However, the use of periodate metal oxides supported on the alumina nanocatalyst support allows for a unique opportunity to not only use the absorptive properties of alumina in purification applications, but also, the immobilized periodate mixed metal oxide on the surface helps promote the oxidation of the adsorbed species. Recently, periodate was described as an emerging advanced oxidant to help promote selective water decontamination. See Zhang, K., et al., (2023), “Promoting selective water decontamination via boosting activation of periodate by nanostructured Ru-supported Co3O4 catalysts”, Journal of Hazardous Materials, 442, 130058 and Niu, L., et al., (2022), “Emerging periodate-based oxidation technologies for water decontamination: A state-of-the-art mechanistic review and future perspectives”, Journal of Environmental Management, 323, 116241. In the work by Niu et al (2022), many different metal supports are described, however they are all activator supports which participate in the oxidation process. See also Li, R., et al., (2022), “Periodate activation for degradation of organic contaminants: Processes, performance and mechanism”, Separation and Purification Technology, 292, 120928; Yang, L., et al., (2022), “Periodate-based oxidation focusing on activation, multivariate-controlled performance and mechanisms for water treatment and purification”, Separation and Purification Technology, 289, 120746; Zhang, K., et al., (2023), “Unraveling the role of iodide in periodate-based water decontamination: Accelerated selective oxidation and formation of iodinated products”, Chemical Engineering Journal, 461, 141879; and Sukhatskiy, Y., et al., (2023), “Periodate-based advanced oxidation processes for wastewater treatment: A review”, Separation and Purification Technology, 304, 122305. In our case, the alumina is acting as a support and adsorbent, no additional metal promoter is needed. The disclosures of all the references discussed above are incorporated herein by reference in their entireties.

A process for the preparation of nanocatalyst media comprises the steps of functionalizing activated alumina by bonding a periodate moiety to the activated alumina to obtain an oxidant and, in some cases, bonding a metal oxide moiety to the oxidant to obtain the nanocatalyst media. For example, the supported mixed metal oxide nanocatalyst media of the present subject matter may be manufactured as follows. Periodate moieties are bonded to the activated alumina to produce an oxidant via a known process at a selected temperature and pressure. The process may comprise filling a large vessel with deionized water to a selected level, adding a selected amount of acid (if any), adding periodate, and gradually adding activated alumina particles. The slurry may be agitated with air, which provides further oxidation potential. The periodate maintains at least a 40%+7 oxidation state while chemically bound to the surface of the alumina.

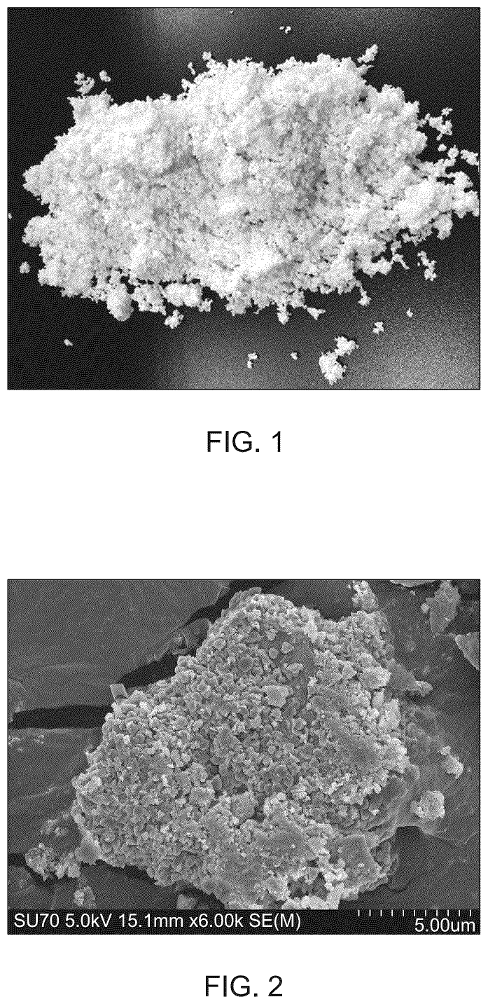

Referring now to FIG. 1, the Figure illustrates nanocatalyst media according to an embodiment of the present invention. The media is white or off-white in color.

FIG. 2 is a scanning electron micrograph (SEM) depicting the morphology thereof at a magnification of 6,000, taken on a Hitachi SU70 at an acceleration voltage of 5.0 kV with a working distance of 15.1 mm.

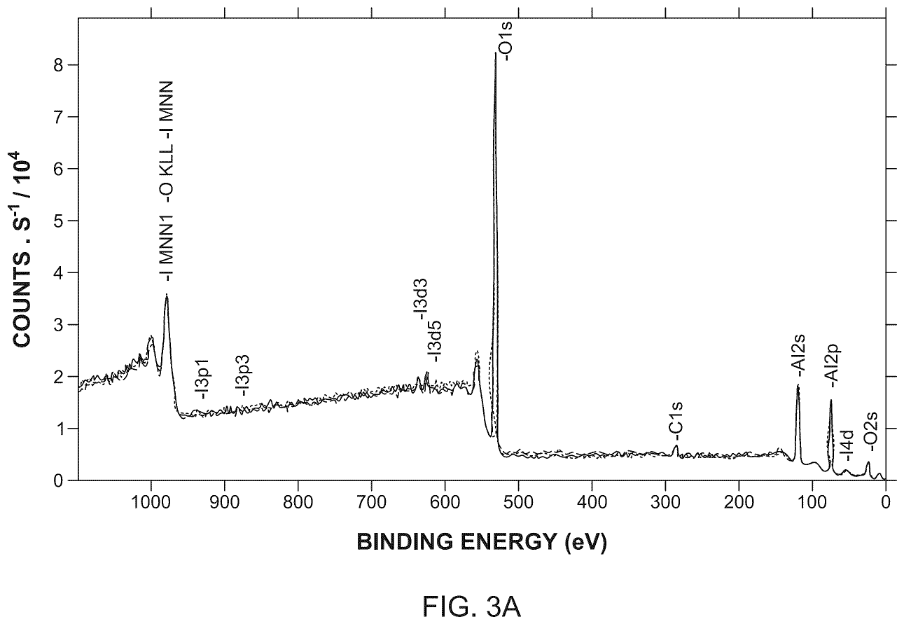

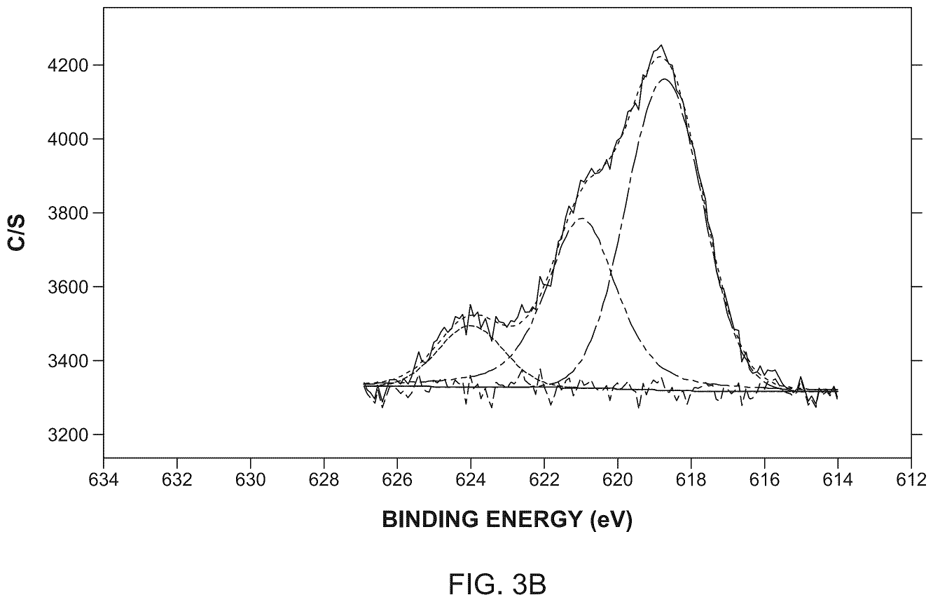

FIG. 3A is a survey scan of an x-ray photoelectron spectrum (XPS) of the nanocatalyst media of FIG. 1, showing that the surface of the sample has aluminum, oxygen, and iodine present. The Y-axis is counts per second divided by 104 and the X-axis is binding energy in electronvolts (eV). Discrepancies in the oxygen region data are due to adsorbed oxygen contamination. Discrepancies in the aluminum signal represent suppression of the aluminum concentration due to the covalent binding of I to the surface.

FIG. 3B provides a detail of the XPS spectrum FIG. 3A, expanding the region at 612-634 eV, showing the overall speciation of the iodine within the sample. In this case, the data suggests that the iodine bound to the surface is 15.2%—IO₄ species and residual being I. The spectra also show additional peaks present in the region which are not attributed to the speciation but instead to the covalent binding of the iodine species to the alumina support. The Y-axis units are counts per second and the X-axis is binding energy.

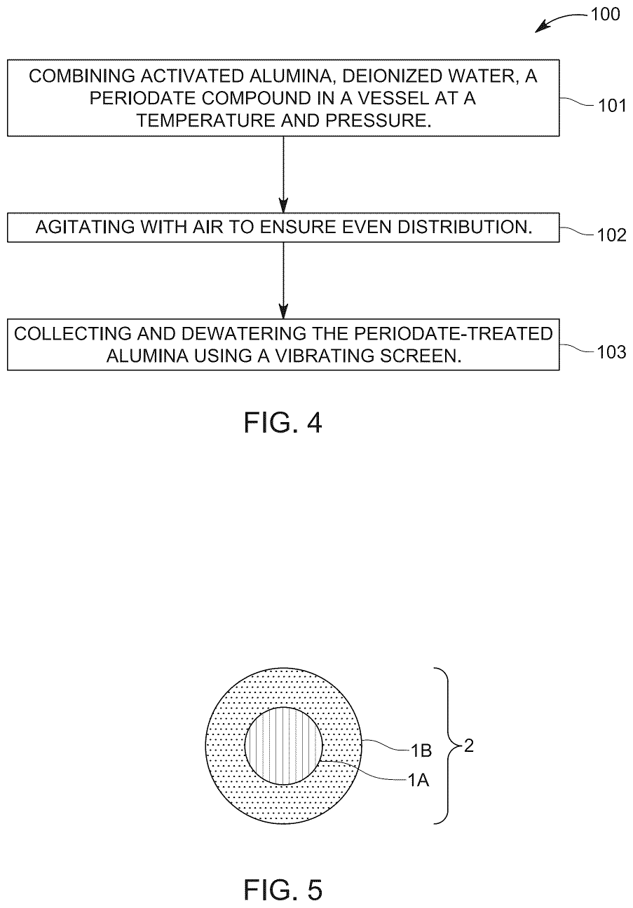

FIG. 4 illustrates a flowchart of the process of preparing the nanocatalyst media of FIG. 1. In the process 100, periodate is bound to activated alumina 101 and agitated 102 to obtain an oxidant. The periodate-treated alumina is collected and dewatered 103. The oxidant is then bonded with metal oxide moieties 104 to obtain the nanocatalyst media.

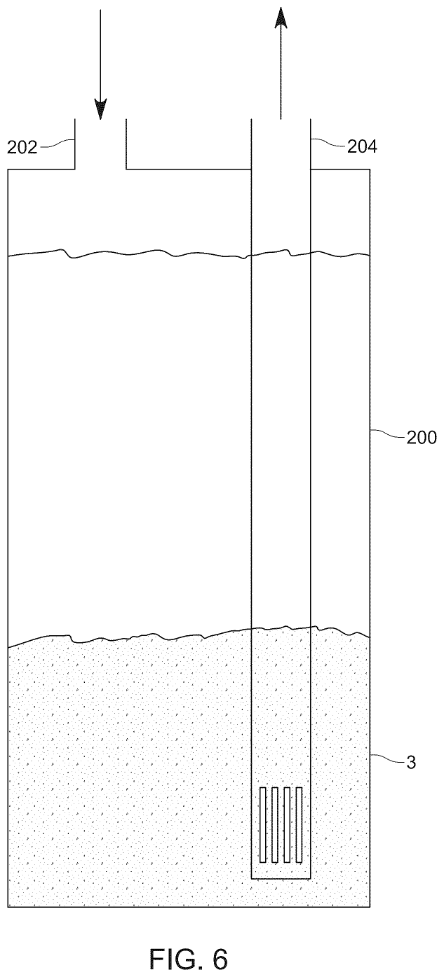

FIG. 5 illustrates the structure of the resulting nanocatalyst media 3, including an oxidant 2 comprising an activated alumina 1a core with a periodate 1b layer and a metal oxide surface layer.

As shown in FIG. 6, a vessel 200 having an inlet 202 and an outlet 204 containing the nanocatalyst media 3 may be used to treat contaminated water entering via the inlet 202, thereby producing treated water leaving via the outlet 204. The contaminated water may be introduced into the vessel and held in contact with the catalytic medium for a selected time or the flow may be continuous. Contaminants in the contaminated water may adsorb onto the nanocatalyst particles and catalytically degrade and/or oxidize to a precipitant. Water without the adsorbed and oxidized contaminants may be withdrawn from the outlet 204.

Accordingly, the present invention provides a supported mixed metal oxide nanocatalyst media comprising activated alumina, a plurality of periodate moieties chemisorbed to the alumina to form an oxidant, and at least one oxide moiety.

In an embodiment, the periodate may be sodium hydrogen periodate (Na3H2IO6). Sodium hydrogen periodate is an exciting oxidizer for the degradation of a variety of contaminants. See, for example, Li, et al., supra.

### Example 1

The process for preparing the media starts with commercially available granular or spherical alumina which has been screened to mesh sizes from 12 to 50. A similar process, using the same ingredients, has also been successfully applied to powders up to 350 mesh. The alumina is added to a large tank with deionized water. A periodate compound is added to the tank and agitation helps ensure even distribution across the media of between 0.1-10 micron thickness. The media is collected and dewatered using a vibrating screen and allowed to dry before packaging.

A photograph of the media is presented in FIG. 1 and a micrograph of the media is presented in FIG. 2. The overall chemical structure of the surface of the media shown in the Figures show that the surface of the media has covalently bound iodine species, with at least 15% of the species present, similar to NaIO4.

A detailed nitrogen adsorption isotherm was fitted using a Barrett, Joyner, and Halenda (BJH) method. The results of the BJH analysis show the pore size and surface area of the iodine functionalized alumina to be 18.05 A and 0.0416 cc/g respectively. This is compared to 18.05 A and 2.77 cc/g respectively for the unfunctionalized alumina. The reduction in the surface area demonstrates the overall “filling” of the pores with iodine.

### Example 2

In Example 2, the media of Example 1 was used on-site to filter drinking water. The test was performed in a small municipal drinking water process facility in Florida at a flow rate of 40 gallons per minute and installed directly following a sand filter. The results of the test show that the media removes 99% of metals such as iron, 62% total organic carbon, and 60% of sulfides.

TABLE 1

| Contaminant | Raw water | Filtered water | Total reduction |
|---|---|---|---|
| Iron | 2.7 | 0.021 | 99% |
| TOC | 3.7 | 1.4 | 62% |
| Sulfide | 0.021 | .0083 | 60% |

### Example 3

A simplified laboratory jar test was carried out by weighing 4 grams of the media of Example 1 with 250 ml of well water and adding a known concentration of analyte. Twelve hours after combining the media, well water, and analyte, the analyte concentration of the water in the jar was measured. The difference between the final concentration and the initial concentration is the concentration of the analyte that was adsorbed. The test does not show the fate of the analyte, just that it was removed from the water.

TABLE 2

| Compounds | RAW water | | Treated water | | % reduction |
|---|---|---|---|---|---|
| cis-1,2-Dichloroethylene | 482 V | ug/L | 226 | ug/L | 53.1% |
| Tetrachloroethylene (PCE) | 270 | ug/L | 18.5 | ug/L | 93.1% |
| trans-1,2-Dichloroethylene | 9.37 | ug/L | 2.67 | ug/L | 71.5% |
| Trichloroethylene (TCE) | 762 | ug/L | 151 | ug/L | 80.2% |
| Vinyl chloride | 15.1 | ug/L | 2.89 | ug/L | 80.9% |

### Example 4

Two quarts of water were received by Bowman Consulting from a well in Arizona. The initial concentration of arsenic was 0.11 mg/L. A 700 mL sample of well water was passed through a column packed with approximately 20 cm³ of the media described in Example 1. The arsenic level was reduced by 97%.

### Example 5

Using a sample of untreated drinking water, Advanced Environmental Laboratories determine the initial concentration of total organic carbon to be 4.8 mg/L. After passing the sample through 20 cm³ of media, the total organic carbon was reduced by over 70%.

### Example 6

A column test was performed to evaluate the kinetics of the media of Example 1. Flow was adjusted through a 25 ml column of the media of Example 1 to achieve an Empty Bed Contact Time (EBCT) of 5 minutes. Approximately 15 bed volumes of water were run through the column before taking samples. The results are shown in Table 3.

TABLE 3

| Contaminant | Raw water | | Treated water | |
|---|---|---|---|---|
| cis-1,2-Dichloroethylene | 174 | ug/L | 50.9 | ug/L |
| Tetrachloroethylene (PCE) | 63.6 | ug/L | 4.78 | ug/L |
| trans-1,2-Dichloroethylene | 2.27 | ug/L | <1.00 | ug/L |
| Trichloroethylene | 199 | ug/L | 30.9 | ug/L |
| Vinyl chloride | 1.48 | ug/L | <0.50 | ug/L |

The column test indicates that recirculating ground water through a cartridge-based filtration system will continuously reduce the contaminant levels until a concentration below the required Maximum Contaminant Levels (MCL) is achieved.

What has been described in this patent specification is supported mixed metal oxide nanocatalyst media. While the present subject matter has been described with reference to an embodiment, the present subject matter is not limited to the current embodiment. On the contrary, many alternatives, changes, and/or modifications will become apparent to a person of ordinary skill in the art (“POSITA”) this patent specification is reviewed. Therefore, all such alternatives, changes, and/or modifications are to be treated as forming a part of the present subject matter insofar as they fall within the spirit and scope of appended claims.

What is claimed:

1. A supported metal oxide nanocatalyst media comprising:
a) an activated alumina, and
b) periodate groups chemisorbed to the activated alumina to form an oxidant;
wherein the supported metal oxide nanocatalyst media is operative as both an oxidant and an adsorbent and is effective to remove organic and inorganic contaminants simultaneously.

2. The supported metal oxide nanocatalyst media of claim 1, wherein the oxidant has a surface thickness ranging from 0.1 microns to about 10 microns.

3. The supported metal oxide nanocatalyst media of claim 1, wherein the periodate groups are selected from metaperiodate and orthoperiodate.

4. The supported metal oxide nanocatalyst media of claim 1, wherein the periodate is sodium hydrogen periodate (Na₃H₂IO₆).

5. The supported metal oxide nanocatalyst media of claim 1, wherein the supported mixed metal oxide nanocatalyst media has a bulk density ranging from about 25 pounds per cubic foot to about 75 pounds per cubic foot.

6. The supported metal oxide nanocatalyst media of claim 1, wherein at least 40% of the periodate groups have an oxidation state of +7 and are covalently bound to the activated alumina.

7. The supported metal oxide nanocatalyst media of claim 1, wherein the supported mixed metal oxide nanocatalyst media is in the form of porous granular particles or powder.

8. The supported metal oxide nanocatalyst media of claim 1, wherein the supported mixed metal oxide nanocatalyst media has a mesh size ranging from about 30 microns to about 2,500 microns.

9. The supported metal oxide nanocatalyst media of claim 1, wherein the supported mixed metal oxide nanocatalyst media has a surface area ranging from about 200 to about 380 square meters per gram.
